(19) United States
(12) Patent Application Publication
(10) Pub. No.: US 2025/0379315 A1
(43) Pub. Date: Dec. 11, 2025

(54) MODULAR BATTERY PACKS

(71) Applicant: Rivian IP Holdings, LLC, Irvine, CA (US)

(72) Inventors: Michael Ryan TILLAPAUGH, Rancho Mission Viejo, CA (US); Casey Taylor DUNN, Mission Viejo, CA (US); Ryan ARENS, Irvine, CA (US); Brandon THAYER, Normal, IL (US); Andrew Robert KRASTS, San Clemente, CA (US); Shubham Pradeep AGNIHOTRI, Irvine, CA (US)

(21) Appl. No.: 19/193,854

(22) Filed: Apr. 29, 2025

Related U.S. Application Data
(60) Provisional application No. 63/657,007, filed on Jun. 6, 2024.

(51) Int. Cl. H01M 50/258; H01M 10/613; H01M 10/625; H01M 50/249; H01M 50/262; H01M 50/289; H01M 50/502

(52) U.S. Cl. CPC H01M 50/258; H01M 10/613; H01M 10/625; H01M 50/249; H01M 50/262; H01M 50/289; H01M 50/502

(57) ABSTRACT

Battery packs, including modular battery packs, hold a variety of numbers of batter modules. When the number is less than the full capacity of battery modules, a bridging component is used to hold various components of the battery pack. When a space within a battery pack frame is unoccupied by a battery module (or battery modules) of the battery pack, the bridging component may hold a cooling manifold of the battery pack. Also, the bridging component may hold busbars used in part to complete a high voltage circuit that includes the battery modules. The bridging component may include clips designed to secure the busbars. The bridging component may further include a metal insert to provide additional structural rigidity. Further, the bridging component may include guides and clips to secure the bridging component to a component (e.g., crossmember) of the battery pack.

### CROSS REFERENCE TO RELATED APPLICATION(S)

The present application claims the benefit of U.S. Provisional Application No. 63/657,007, entitled “MODULAR BATTERY PACKS”, filed Jun. 6, 2024, the entirety of which is incorporated herein for reference.

### INTRODUCTION

Batteries are often used as a source of power, including as a source of power for electric vehicles that include wheels that are driven by an electric motor that receives power from the batteries. A battery may include several battery cells carried within a module and/or a carrier. Aspects of the present disclosure provide structural components used to hold and/or carry components of a battery pack.

### SUMMARY

An enclosure (e.g., battery pack frame) may be used to hold a battery pack with a different number of battery modules. Battery packs may vary in terms of the number of battery modules. In one or more implementations, when a battery pack includes a number of battery modules fewer than the full capacity that the battery pack frame may hold, a bridging component is disposed in a space (representing an unoccupied region) in the battery pack frame, and carries various components for the battery pack.

In one or more aspects of the present disclosure, an apparatus is described. The apparatus may include a bridging component including a first portion configured to hold a cooling manifold at a first elevation. The apparatus may further include a second portion configured to hold one or more busbars at a second elevation different from the first elevation. The second elevation may be greater than the first elevation.

The bridging component may further include a clip configured to at least partially cover a busbar of the one or more busbars. The clip may be coupled to the second portion by a hinge. The clip may include a spring tab configured to contact the busbar in a closed position of the clip. The clip may include an extension configured to cover an exposed portion of the busbar in a closed position of the clip.

The bridging component may further include a column formed from a first material. The bridging component may further include an insert positioned in the column, the insert including a second material different from the first material. The bridging component may further include snap. The column may include a guide configured to receive a crossmember, and the snap may be configured to secure with the crossmember in response the guide receiving the crossmember.

In one or more aspects of the present disclosure, a battery subassembly is described. The battery subassembly may include an enclosure for a battery pack. The enclosure may define an internal volume configured to receive battery modules. The battery subassembly may further include a crossmember positioned in the internal volume and coupled with the enclosure. The enclosure and crossmember may define a first space in the internal volume. The battery subassembly may further include a bridging component positioned in the first space. The bridging component may include a first portion configured to hold a cooling manifold for the battery modules. The bridging component may further include second portion configured to hold a first busbar that electrically couples with the battery modules.

The enclosure and crossmember may further define a second space in the internal volume, and the battery modules are positioned in the second space. The battery modules may not be located in the first space.

The crossmember includes an opening. The bridging component may further include a column positioned in the opening, the column formed from a non-metal. The bridging component may further include an insert positioned in the column, the insert including a metal. The crossmember may include an opening, and the bridging component may pass through the opening.

The bridging component may further include a clip configured to at least partially cover the first busbar. The clip may be coupled to the second portion by a hinge. The clip may include a spring tab configured to contact the first busbar in a closed position of the clip. The bridging component may further include an extension configured to cover an exposed portion of the first busbar in a closed position of the clip. The battery modules may not be located in the first space.

In one or more aspects of the present disclosure, a vehicle is described. The vehicle may include a battery subassembly. The battery subassembly may include an enclosure for a battery pack. The enclosure may define an internal volume including a first space configured to receive a first battery module and a second space configured to receive a second battery module. The battery subassembly may further include a crossmember positioned in the internal volume and coupled with the enclosure. The battery subassembly may further include a bridging component spanning the second space. The bridging component may include a first portion configured to hold a cooling manifold for the first battery module and the second battery module. The bridging component may further include a second portion configured to hold a first busbar that electrically couples with the first battery module and the second battery module. The first battery module and the second battery module may not be located in the second space. The first battery module and the second battery module may be located in the first space.

### BRIEF DESCRIPTION OF THE DRAWINGS

Certain features of the subject technology are set forth in the appended claims. However, for purpose of explanation, several embodiments of the subject technology are set forth in the following figures.

FIG. 1A and FIG. 1B illustrate schematic perspective side views of example implementations of a vehicle having a battery pack, in accordance with one or more implementations of the present disclosure.

FIG. 1C illustrates a schematic perspective view of a building having a battery pack, in accordance with one or more implementations of the present disclosure.

FIG. 2A illustrates a schematic perspective view of a battery pack, in accordance with one or more implementations of the present disclosure.

FIG. 2B illustrates schematic perspective views of various battery modules that may be included in a battery pack, in accordance with one or more implementations of the present disclosure.

FIG. 2C illustrates a cross-sectional end view of a battery cell, in accordance with one or more implementations of the present disclosure.

FIG. 2D illustrates a cross-sectional perspective view of a cylindrical battery cell, in accordance with one or more implementations.

FIG. 2E illustrates a cross-sectional perspective view of a prismatic battery cell, in accordance with one or more implementations of the present disclosure.

FIG. 2F illustrates a cross-sectional perspective view of a pouch battery cell, in accordance with one or more implementations of the present disclosure.

FIG. 3 illustrates a perspective view of a cover for a battery module in accordance with one or more implementations of the present disclosure.

FIG. 4 illustrates an exploded perspective view of the battery module shown in FIG. 3 in accordance with one or more implementations of the present disclosure.

FIG. 5 illustrates a perspective view of an example battery cell in accordance with one or more implementations of the present disclosure.

FIG. 6A, FIG. 6B, and FIG. 6C illustrate perspective views of examples of battery packs, in accordance with one or more implementations of the present disclosure.

FIG. 7 illustrates a perspective view of an example of a bridging component, in accordance with one or more implementations of the present disclosure.

FIG. 8 illustrates a side view of an example of a bridging component, in accordance with one or more implementations of the present disclosure.

FIG. 9 illustrates a perspective view of an example of a battery pack, further showing a bridging component integrated with the battery pack, in accordance with one or more implementations of the present disclosure.

FIG. 10 illustrates an enlarged aerial view of an example of a battery pack and a bridging component, in accordance with one or more implementations of the present disclosure.

FIG. 11A and FIG. 11B illustrate enlarged aerial views of an example of a clip of a bridging component, in accordance with one or more implementations of the present disclosure.

FIG. 12 illustrates an enlarged perspective view of a bridging component, showing additional features of the bridging component, in accordance with one or more implementations of the present disclosure.

FIG. 13 illustrates an enlarged perspective view of the battery pack, showing the bridging component coupled with the crossmember, in accordance with one or more implementations of the present disclosure.

FIG. 14 illustrates an exploded view of an alternate example of a bridging component, in accordance with one or more implementations of the present disclosure.

FIG. 15 illustrates a perspective view of an example of a battery pack, further showing a bridging component integrated with the battery pack, in accordance with one or more implementations of the present disclosure.

FIG. 16 illustrates a flow diagram showing an example of a process that may be performed for forming a bridging component, in accordance with one or more implementations of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The present disclosure is directed to battery packs, including modular battery packs, that may include a variety of battery modules. As described herein, a battery pack may be modular in that the battery pack may include a different number of battery modules. Battery packs described herein may include an enclosure (e.g., battery pack frame) that provides an internal volume for a variety of battery modules in terms of the number of total battery modules. As an example, the enclosure may hold nine battery modules, which may correspond to the enclosure holding a full capacity of battery modules. Alternatively, the enclosure may hold less than the full capacity (e.g., eight or less battery modules). When less than the full capacity of battery modules are positioned in the enclosure, a space (that would otherwise be occupied in the enclosure) is present in the enclosure. As a result, the battery pack may incorporate some devices into the space to hold components of the battery pack. For example, the battery pack may include a bridging component designed to support various component (e.g., busbars, cooling manifold) in instances when a battery pack includes a fewer number of modules that could otherwise be carried by a battery pack frame. The bridging component may hold additional busbars, one of which allows high voltage to exit a battery module of the battery pack and another of which allows the high voltage to enter another battery module. The bridging component may further include integrated clips designed to secure the busbars. While the integrated clips include spring tabs for enhanced retention force, the integrated clips are nonetheless designed to permit relative movement of the busbars in order align respective fastener holes of the busbar and the bridging component. Additionally, the clips include an extension such that when the clips are folded over and onto the busbar, the extension covers an exposed portion of the busbar. Thus, the bridging component provides touch safety and electrical isolation via the clips. While the bridging component may be formed from a non-metal (e.g., plastic), some regions of the bridging component are reinforced with a metal insert.

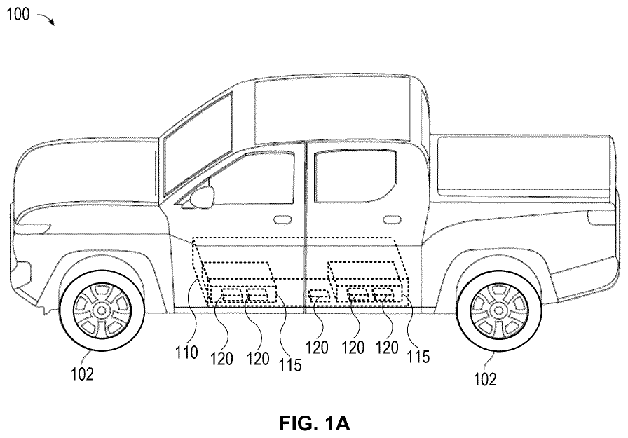

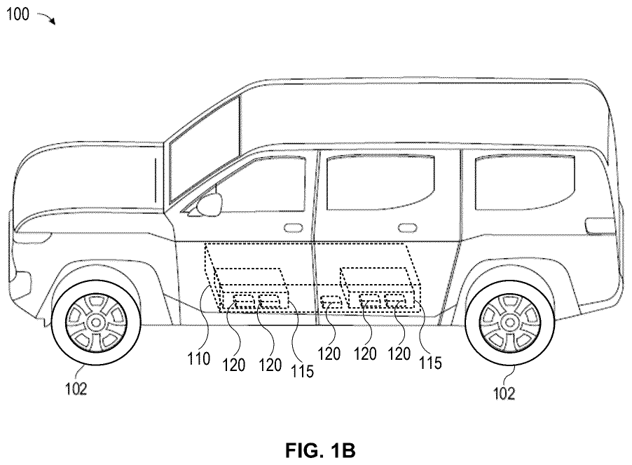

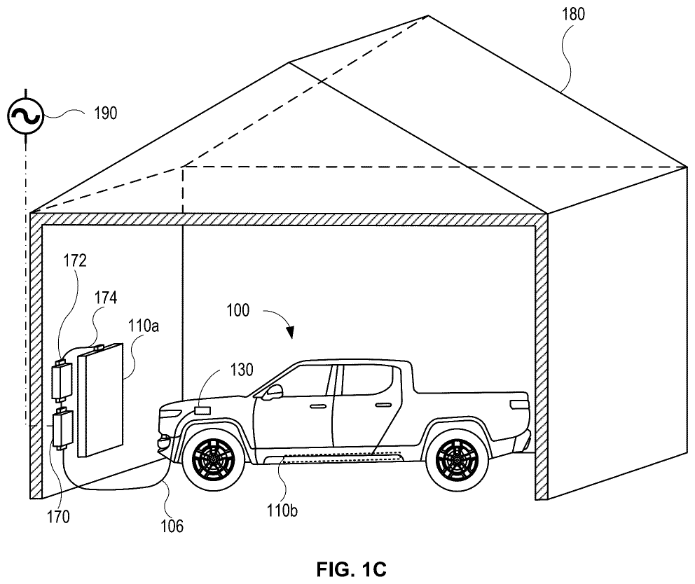

FIG. 1A illustrates an example implementation of a moveable apparatus as described herein. In the example of FIG. 1A, a moveable apparatus is implemented as a vehicle 100. As shown, the vehicle 100 may include one or more battery packs, such as battery pack 110. The battery pack 110 may be coupled to one or more electrical systems of the vehicle 100 to provide power to the electrical systems.

In one or more implementations, the vehicle 100 may be an electric vehicle having one or more electric motors that drive the wheels 102 of the vehicle 100 using electric power from the battery pack 110. In one or more implementations, the vehicle 100 may also, or alternatively, include one or more engines, or motors, including chemically-powered engines, such as a gas-powered engine or a fuel cell powered motor. For example, in one or more implementations, the vehicle 100 includes one or more electric motors, and the vehicle 100 takes the form of a fully electric or partially electric (e.g., hybrid or plug-in hybrid) vehicle.

In the example of FIG. 1A, the vehicle 100 is implemented as a truck (e.g., a pickup truck) having a battery pack 110. As shown, the battery pack 110 may include one or more battery modules 115, which may include one or more battery cells 120. As shown in FIG. 1A, the battery pack 110 may also, or alternatively, include one or more battery cells 120 mounted directly in the battery pack 110 (e.g., in a cell-to-pack configuration). In one or more implementations, the battery pack 110 may be provided without the battery modules 115 and with the battery cells 120 mounted directly in the battery pack 110 (e.g., in a cell-to-pack configuration) and/or in other battery units that are installed in the battery pack 110. The battery pack 110 may include multiple energy storage devices that can be arranged into such as battery modules or battery units. A battery unit or module can include an assembly of cells that can be combined with other elements (e.g., structural frame, thermal management devices) that can protect the assembly of cells from heat, shock and/or vibrations.

Each of the battery cells 120 may be included a battery, a battery unit, a battery module and/or a battery pack to power components of the vehicle 100. For example, a battery cell housing of the battery cells 120 can be disposed in the battery module 115, the battery pack 110, a battery array, or other battery unit installed in the vehicle 100.

As discussed in further detail hereinafter, the battery cells 120 may be provided with a battery cell housing that can be provided with any of various outer shapes. The battery cell housing may be a rigid housing in some implementations (e.g., for cylindrical or prismatic battery cells). The battery cell housing may also, or alternatively, be formed as a pouch or other flexible or malleable housing for the battery cell in some implementations. In various other implementations, the battery cell housing can be provided with any other suitable outer shape, such as a triangular outer shape, a square outer shape, a rectangular outer shape, a pentagonal outer shape, a hexagonal outer shape, or any other suitable outer shape. In some implementations, the battery pack 110 may not include modules (e.g., the battery pack may be module-free). For example, the battery pack 110 can have a module-free or cell-to-pack configuration in which the battery cells 120 are arranged directly into the battery pack 110 without assembly into a battery module 115. In one or more implementations, the vehicle 100 may include one or more busbars, electrical connectors, or other charge collecting, current collecting, and/or coupling components to provide electrical power from the battery pack 110 to various systems or components of the vehicle 100. In one or more implementations, the vehicle 100 may include control circuitry such as a power stage circuit that can be used to convert DC power from the battery pack 110 into AC power for one or more components and/or systems of the vehicle (e.g., including one or more power outlets of the vehicle). The power stage circuit can be provided as part of the battery pack 110 or separately from the battery pack 110 within the vehicle 100.

FIG. 1B illustrates another implementation in which the vehicle 100 is implemented as a sport utility vehicle (SUV), such as an electric sport utility vehicle. In the example of FIG. 1B, the vehicle 100 may include a cargo storage area that is enclosed within the vehicle 100 (e.g., behind a row of seats within a cabin of the vehicle 100). In other implementations, the vehicle 100 may be implemented as another type of electric truck, an electric delivery van, an electric automobile, an electric car, an electric motorcycle, an electric scooter, an electric bicycle, an electric passenger vehicle, an electric passenger or commercial truck, a hybrid vehicle, an aircraft, a watercraft, and/or any other movable apparatus having a battery pack 110 (e.g., a battery pack or other battery unit that powers the propulsion or drive components of the moveable apparatus).

In one or more implementations, the battery pack 110, battery modules 115, battery cells 120, and/or any other battery unit as described herein may also, or alternatively, be implemented as an electrical power supply and/or energy storage system in a building, such as a residential home or commercial building. For example, FIG. 1C illustrates an example in which a battery pack 110a is implemented in a building 180. The building 180 may be a residential building, a commercial building, or any other building. As shown, in one or more implementations, the battery pack 110a may be mounted to a wall of the building 180.

As shown, the battery pack 110a that is installed in the building 180 may be coupled (e.g., electrically coupled) to the battery pack 110b in the vehicle 100, such as via a cable/connector 106 that can be connected to a charging port 130 of the vehicle 100, an electric vehicle supply equipment 170 (EVSE), a power stage circuit 172, and/or a cable/connector 174. For example, the cable/connector 106 may be coupled to the EVSE 170, which may be coupled to the battery pack 110a via the power stage circuit 172, and/or may be coupled to an external power source 190. In this way, either the external power source 190 or the battery pack 110a may be used as an external power source to charge the battery pack 110b in some use cases. In one or more implementations, the battery pack 110a may also, or alternatively, be coupled (e.g., via a cable/connector 174, the power stage circuit 172, and the EVSE 170) to the external power source 190. The external power source 190 may take the form of a solar power source, a wind power source, and/or an electrical grid of a city, town, or other geographic region (e.g., electrical grid that is powered by a remote power plant). During, for example, instances when the battery pack 110b is not coupled to the battery pack 110a, the battery pack 110a may couple (e.g., using the power stage circuit 172) to the external power source 190 to charge up and store electrical energy. In some use cases, this stored electrical energy in the battery pack 110a may later be used to charge the battery pack 110b (e.g., during times when solar power or wind power is not available, in the case of a regional or local power outage for the building 180, and/or during a period of high rates for access to the electrical grid).

In one or more implementations, the power stage circuit 172 may electrically couple the battery pack 110a to an electrical system of the building 180. For example, the power stage circuit 172 may convert DC power from the battery pack 110a into AC power for one or more loads in the building 180. Exemplary loads coupled, via one or more electrical outlets coupled, to the battery pack 110a may include one or more lights, lamps, appliances, fans, heaters, air conditioners, and/or any other electrical components or electrical loads. The power stage circuit 172 may include control circuitry that is operable to switchably couple the battery pack 110a between the external power source 190 and one or more electrical outlets and/or other electrical loads in the electrical system of the building 180. In one or more implementations, the vehicle 100 may include a power stage circuit (not shown in FIG. 1C) that can be used to convert power received from the EVSE 170 to DC power that is used to power/charge the battery pack 110b, and/or to convert DC power from the battery pack 110 into AC power for one or more electrical systems, components, and/or loads of the vehicle 100.

In one or more use cases, the battery pack 110a may be used as a source of electrical power for the building 180, such as during times when solar power or wind power is not available, in the case of a regional or local power outage for the building 180, and/or during a period of high rates for access to the electrical grid, as non-limiting examples. In one or more other use cases, the battery pack 110b may be used to charge the battery pack 110a and/or to power the electrical system of the building 180 (e.g., in a use case in which the battery pack 110a is low on or out of stored energy and in which solar power or wind power is not available, a regional or local power outage occurs for the building 180, and/or a period of high rates for access to the electrical grid occurs, as non-limiting examples.

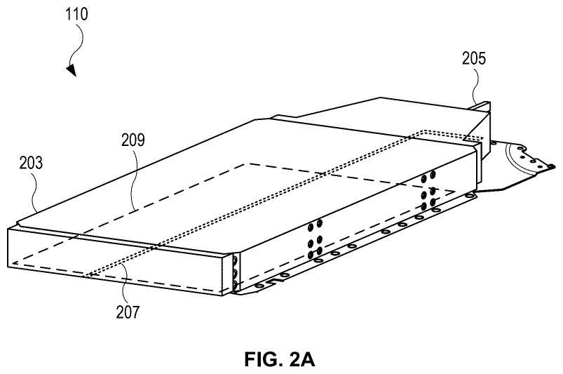

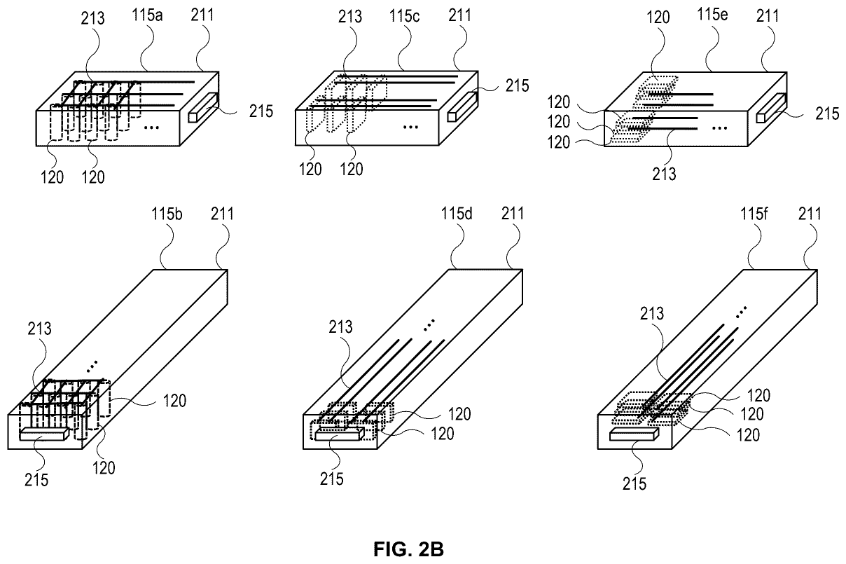

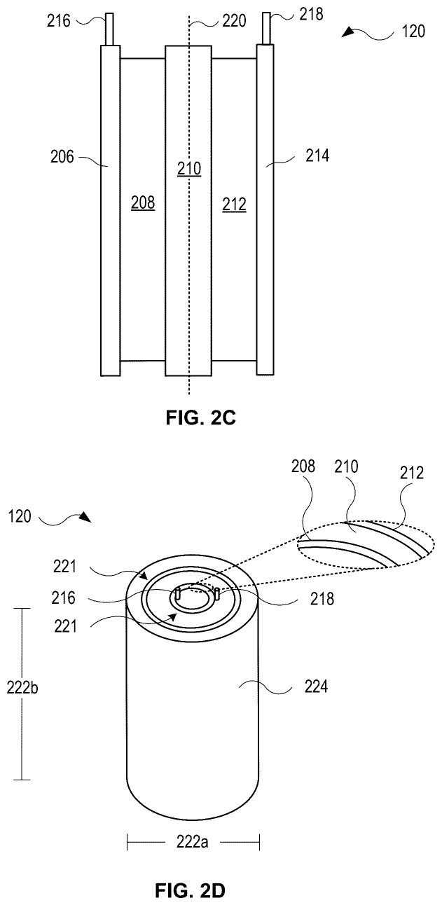

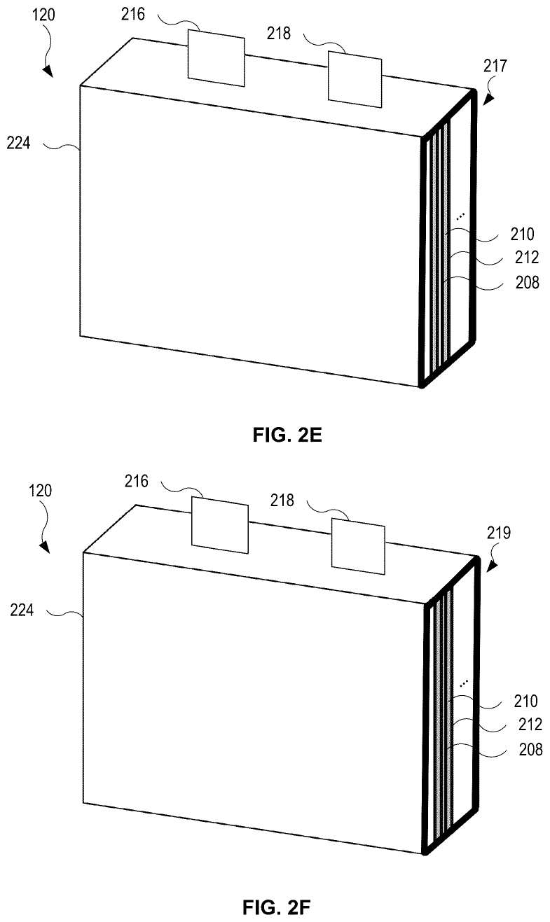

FIG. 2A illustrates an example of a battery pack 110. As shown, the battery pack 110 may include a battery pack frame 203 (e.g., a battery pack housing or pack frame). The battery pack frame 203 may house or enclose one or more battery modules and/or one or more battery cells, and/or other battery pack components of the battery pack 110. In one or more implementations, the battery pack frame 203 may include or form a shielding structure on an outer surface thereof (e.g., a bottom thereof and/or underneath one or more battery module, battery units, batteries, and/or battery cells) to protect the battery module, battery units, batteries, and/or battery cells from external conditions (e.g., if the battery pack 110 is installed in a vehicle and the vehicle is driven over rough terrain, such as off-road terrain, trenches, rocks, rivers, streams, etc.).

The battery pack 110 may include battery cells (e.g., directly installed within the battery pack 110, or within batteries, battery units, and/or battery modules as described herein) and/or battery modules, and one or more conductive coupling elements for coupling a voltage generated by the battery cells to a power-consuming component, such as the vehicle 100 (shown in FIGS. 1A, 1B, and 1C) and/or an electrical system of the building 180 (shown in FIG. 1C). For example, the conductive coupling elements may include internal connectors and/or contactors that couple together multiple battery cells, battery units, batteries, and/or multiple battery modules within the battery pack frame 203 to generate a desired output voltage for the battery pack 110. The battery pack 110 may also include one or more external connection ports, such as an electrical contact 205 (e.g., a high voltage terminal or connector). As shown, the battery pack 110 may include an electrical contact 205 may electrically couple an external load (e.g., the vehicle or an electrical system of the building) to the battery modules and/or battery cells in the battery pack 110. In this regard, an electrical cable (e.g., cable/connector 106) may be connected between the electrical contact 205 and an electrical system of a vehicle or a building, to provide electrical power to the vehicle or the building.

In one or more implementations, the battery pack 110 may include one or more thermal control structures 207 (e.g., cooling lines and/or plates and/or heating lines and/or plates). For example, thermal control structures 207 may couple thermal control structures and/or fluids to the battery modules, battery units, batteries, and/or battery cells within the battery pack frame 203, such as by distributing fluid through the battery pack 110. The thermal control structures 207 may form a part of a thermal/temperature control or heat exchange system that includes one or more thermal components 209, which may include plates or bladders that are disposed in thermal contact with one or more battery modules and/or battery cells disposed within the battery pack frame 203. The one or more thermal components 209 may be positioned in contact with one or more battery modules, battery units, batteries, and/or battery cells within the battery pack frame 203. The one or multiple thermal control structures 207 may be provided for each of several top and bottom battery module pairs.

FIG. 2B depicts various examples of battery modules that may be disposed in a battery pack (e.g., within the battery pack frame 203 of the battery pack 110, shown in FIG. 2A). In an example of FIG. 2B, a battery module 115a is shown that includes a battery module housing 211 having a rectangular cuboid shape with a length that is substantially similar to its width. In this example, the battery module 115a includes battery cells 120 implemented as cylindrical battery cells. The battery module 115a further includes rows and columns of cylindrical battery cells that are coupled together by an interconnect structure 213 (e.g., a current connector assembly or CCA). For example, the interconnect structure 213 may couple together the positive terminals of the battery cells 120, and/or couple together the negative battery terminals of the battery cells 120. As shown, the battery module 115a may further include a busbar 215 that functions as a charge collector. For example, the busbar 215 may be electrically coupled to the interconnect structure 213 to collect the charge generated by the battery cells 120 to provide a high voltage output from the battery module 115a.

FIG. 2B also shows a battery module 115b having an elongate shape. The battery module 115b may include a battery module housing 211 in which the length of the (e.g., extending along a direction from a front end to a rear end of the battery module housing 211) is substantially greater than a width (e.g., in a transverse direction to the direction from the front end to the rear end) of the battery module housing 211). In this regard, the battery module 115b (representative of one or more similar battery modules) may span the entire front-to-back length of a battery pack within a battery pack frame. As shown, the battery module 115a may further include an interconnect structure 213 electrically coupled to a busbar 215, allowing the busbar 215 may be electrically coupled to the interconnect structure 213 to collect the charge generated by battery cells 120 of the battery module 115b to provide a high voltage output from the battery module 115b.

In the implementations of battery module 115a and battery module 115a, the battery cells 120 are implemented as cylindrical battery cells. However, in other implementations, a battery module may include battery cells having other form factors, such as a battery cells having a right prismatic outer shape (e.g., a prismatic cell), or a pouch cell implementation of a battery cell. As an example, FIG. 2B also shows a battery module 115c having a battery module housing 211 with a rectangular cuboid shape with a length that is substantially similar to its width and including battery cells 120 implemented as prismatic battery cells. In this example, the battery module 115c includes rows and columns of battery cells 120 that are coupled together by an interconnect structure 213 (e.g., a current collector assembly or CCA). For example, the interconnect structure 213 may couple together the positive terminals of the battery cells 120 and/or couple together the negative battery terminals of the battery cells 120. As shown, the battery module 115c may include a busbar 215 that functions as a charge collector. For example, the busbar 215 may be electrically coupled to the interconnect structure 213 to collect the charge generated by the battery cells 120 to provide a high voltage output from the battery module 115c.

FIG. 2B also shows a battery module 115d including prismatic battery cells and having an elongate shape. For example, the battery module 115d includes a battery module housing 211 in which the length of the battery module housing 211 is substantially greater than a width of the battery module housing 211. In this regard, the battery module 115d (representative of one or more similar battery modules) may span the entire front-to-back length of a battery pack within a battery pack frame. As shown, the battery module 115d may also include an interconnect structure 213 and a busbar 215 electrically coupled to the interconnect structure 213. For example, the busbar 215 may be electrically coupled to the interconnect structure 213 to collect the charge generated by the battery cells 120 to provide a high voltage output from the battery module 115d.

As another example, FIG. 2B also shows a battery module 115e having a battery module housing 211 having a rectangular cuboid shape with a length that is substantially similar to its width. The battery module housing 211 may carry battery cells 120, each of which being implemented as pouch battery cells. In this example, the battery module 115e includes rows and columns of pouch battery cells that are coupled together by an interconnect structure 213 (e.g., a current collector assembly or CCA). For example, the interconnect structure 213 may couple together the positive terminals of the battery cells 120 and couple together the negative battery terminals of the battery cells 120. As shown, the battery module 115e may also include a busbar 215 electrically coupled to the interconnect structure 213. For example, the busbar 215 may be electrically coupled to the interconnect structure 213 to collect the charge generated by the battery cells 120 to provide a high voltage output from the battery module 115c.

FIG. 2B also shows a battery module 115f including pouch battery cells and having an elongate shape. For example, the battery module 115d includes a battery module housing 211 in which the length of the battery module housing 211 is substantially greater than a width of the battery module housing 211. In this regard, the battery module 115d (representative of one or more similar battery modules) may span the entire front-to-back length of a battery pack within a battery pack frame. In this regard, the battery module 115f (representative of one or more similar battery modules) may span the entire front-to-back length of a battery pack within a battery pack frame. As shown, the battery module 115f may also include an interconnect structure 213 and a busbar 215 electrically coupled to the interconnect structure 213. For example, the busbar 215 may be electrically coupled to the interconnect structure 213 to collect the charge generated by the battery cells 120 to provide a high voltage output from the battery module 115f.

In various implementations, a battery pack (e.g., battery pack 110 shown in FIG. 2A) may be provided with one or more of any of the battery modules 115a, 115b, 115c, 115d, 115c, and 115f. In one or more other implementations, a battery pack may be provided without any of the battery modules 115a, 115b, 115c, 115d, 115e, and 115f (e.g., in a cell-to-pack implementation).

In one or more implementations, battery modules in any of the implementations of FIG. 2B may be coupled (e.g., in series) to a current collector of a battery pack. In one or more implementations, the current collector may be coupled, via a high voltage harness, to one or more external connectors on a battery pack (e.g., electrical contact 205 of the battery pack 110, shown in FIG. 2A). In one or more implementations, a battery pack may be provided without any battery modules 115. For example, in a cell-to-pack configuration, the battery cells 120 are arranged directly into a battery pack without assembly into a battery module (e.g., without including the battery module housing 211). For example, a battery pack frame of a battery pack (e.g., the battery pack frame 203 of the battery pack 110 shown in FIG. 2A) may include or define a plurality of structures for positioning of the battery cells 120 directly within the battery pack frame.

FIG. 2C illustrates a cross-sectional end view of a portion of a battery cell 120. As shown, the battery cell 120 may include an anode 208, an electrolyte 210, and a cathode 212. As shown, the anode 208 may include or be electrically coupled to a first current collector 206 (e.g., a metal layer such as a layer of copper foil or other metal foil). Also, the cathode 212 may include or be electrically coupled to a second current collector 214 (e.g., a metal layer such as a layer of aluminum foil or other metal foil). The battery cell 120 may further include a terminal 216 (e.g., a negative terminal) coupled to the anode 208 (e.g., via the first current collector 206) and a terminal 218 (e.g., a positive terminal) coupled to the cathode (e.g., via the second current collector 214). In various implementations, the electrolyte 210 may take the form of a liquid electrolyte layer or a solid electrolyte layer. In one or more implementations in which the electrolyte 210 is a liquid electrolyte layer, the battery cell 120 may include a separator layer 220 that separates the anode 208 from the cathode 212. In one or more implementations in which the electrolyte 210 is a solid electrolyte layer, the electrolyte 210 may function as both separator layer and an electrolyte layer.

In one or more implementations, the battery cell 120 may be implemented as a lithium ion battery cell in which the anode 208 is formed from a carbonaceous material (e.g., graphite or silicon-carbon). In these implementations, lithium ions can move from the anode 208, through the electrolyte 210, to the cathode 212 during discharge of the battery cell 120 (e.g., and through the electrolyte 210 from the cathode 212 to the anode 208 during charging of the battery cell 120). For example, the anode 208 may be formed from a graphite material that is coated on a copper foil corresponding to the first current collector 206. In these lithium ion implementations, the cathode 212 may be formed from one or more metal oxides (e.g., a lithium cobalt oxide, a lithium manganese oxide, a lithium nickel manganese cobalt oxide (NMC), or the like) and/or a lithium iron phosphate. In an implementation in which the battery cell 120 is implemented as a lithium-ion battery cell, the electrolyte 210 may include a lithium salt in an organic solvent.

The separator layer 220 may be formed from one or more insulating materials (e.g., a polymer such as polyethylene, polypropylene, polyolefin, and/or polyamide, or other insulating materials such as rubber, glass, cellulose or the like). The separator layer 220 may prevent contact between the anode 208 and the cathode 212, and may be permeable to the electrolyte 210 and/or ions within the electrolyte 210. In one or more implementations, the battery cell 120 may be implemented as a lithium polymer battery cell having a dry solid polymer electrolyte and/or a gel polymer electrolyte.

Although some examples are described herein in which the battery cell 120 is implemented as lithium-ion battery cells, the battery cell 120 may be implemented using other battery cell technologies, such as nickel-metal hydride battery cells, lead-acid battery cells, and/or ultracapacitor cells. For example, in a nickel-metal hydride battery cell, the anode 208 may be formed from a hydrogen-absorbing alloy and the cathode 212 may be formed from a nickel oxide-hydroxide. In the example of a nickel-metal hydride battery cell, the electrolyte 210 may be formed from an aqueous potassium hydroxide in one or more examples.

The battery cell 120 may be implemented as a lithium sulfur battery cell in one or more other implementations. For example, in a lithium sulfur battery cell, the anode 208 may be formed at least in part from lithium, the cathode 212 may be formed from at least in part form sulfur, and the electrolyte 210 may be formed from a cyclic ether, a short-chain ether, a glycol ether, an ionic liquid, a super-saturated salt-solvent mixture, a polymer-gelled organic media, a solid polymer, a solid inorganic glass, and/or other suitable electrolyte materials. In various implementations, the anode 208, the electrolyte 210, and the cathode 212 can be packaged into a battery cell housing having any of various shapes, and/or sizes, and/or formed from any of various suitable materials. For example, the battery cell 120 may include a cylindrical, rectangular, square, cubic, flat, pouch, elongated, or prismatic outer shape.

As depicted in FIG. 2D, for example, a battery cell 120 may be implemented as a cylindrical cell. Accordingly, the battery cell 120 includes dimension 222a (e.g., cylinder diameter, battery cell diameter) and a dimension 222b (e.g., cylinder length). The battery cell 120, and other battery cells described herein, may include dimensional information derived from a 4-number code. For example, in some embodiments, the battery cell 120 includes an XXYY battery cell, in which “XX” refers to the dimension 222a in millimeters (mm) and “YY” refers to the dimension in mm. Accordingly, when the battery cell 120 includes a “2170” battery cell, the dimension 222a is 21 mm and the dimensions 222b is 70 mm. Alternatively, when the battery cell 120 includes a “4680” battery cell, the dimension 222a is 46 mm and the dimensions 222b is 80 mm. The foregoing examples of dimensional characteristics for the battery cell 120 should not be construed as limiting, and the battery cell 120, and other battery cells described herein with a cylindrical form factor, may include various dimension. For example, the dimension 222a and the dimension 222b may be greater than 46 mm and 80 mm, respectively.

FIG. 2D illustrates a battery cell 120 that includes a cell housing 224 having a cylindrical outer shape. As shown in the enlarged view, the anode 208, the electrolyte 210, and the cathode 212 may be rolled into one or more windings 221. The one or more windings 221 may include one or more substantially cylindrical windings, as a non-limiting example. As shown, one or more windings 221 of the anode 208, the electrolyte 210, and the cathode 212 (e.g., and/or one or more separator layers such as separator layer 220 shown in FIG. 2C) may be disposed within the cell housing 224. For example, a separator layer may be disposed between adjacent ones of the one or more windings 221. Additionally, the battery cell 120 in the cylindrical cell implementation of FIG. 2D includes a terminal 216 and a terminal 218. The terminal 218 may include a first polarity terminal, such as a positive terminal, which is coupled to the cathode 212. The terminal 216 may include a second polarity terminal, such as a negative terminal, which is coupled to the anode 208. The terminals 216 and 218 can be made from electrically conductive materials to carry electrical current from the battery cell 120 directly or indirectly (e.g., via a current carrier assembly, a busbar, and/or other electrical coupling structures) to an electrical load, such as a component or system of a vehicle or a building shown and/or described herein. However, the cylindrical cell implementation of FIG. 2D is merely illustrative, and other implementations of the battery cells 120 are contemplated.

FIG. 2E illustrates an example in which the battery cell 120 is implemented as a prismatic cell. As shown, the battery cell 120 may include a cell housing 224 having a right prismatic outer shape. Also, one or more layers of the anode 208, the cathode 212, and the electrolyte 210 disposed therebetween may be disposed (e.g., with separator materials between the layers) within the cell housing 224. As examples, multiple layers of the anode 208, electrolyte 210, and cathode 212 can be stacked (e.g., with separator materials between each layer), or a single layer of the anode 208, electrolyte 210, and cathode 212 can be formed into a flattened spiral shape and provided in the cell housing 224. The cell housing 224 may include a cross-sectional width 217 that is relatively thick and is formed from a rigid material. For example, the cell housing 224 may be formed from a welded, stamped, deep drawn, and/or impact extruded metal sheet, such as a welded, stamped, deep drawn, and/or impact extruded aluminum sheet. The cross-sectional width 217 of the cell housing 224 may be as much as, or more than 1 millimeter (mm) to provide a rigid housing for the prismatic battery cell. In one or more implementations, a terminal 216 and a terminal 218 in the prismatic cell implementation of FIG. 2E may be formed from a feedthrough conductor that is insulated from the cell housing 224 (e.g., a glass to metal feedthrough) as the conductor passes through to cell housing 224 to expose the terminal 216 and the terminal 218 outside the cell housing 224 in order to contact an interconnect structure (e.g., interconnect structure 213 shown in FIG. 2B). However, this implementation of FIG. 2E is also illustrative and yet other implementations of the battery cell 120 are contemplated.

FIG. 2F illustrates an example in which the battery cell 120 is implemented as a pouch cell. As shown, the battery cell 120 may include a cell housing 224 that forms a flexible or malleable pouch housing. One or more layers of the anode 208, the cathode 212, and the electrolyte 210 disposed therebetween may be disposed (e.g., with separator materials between the layers) within the cell housing 224. In the implementation of FIG. 2F, the cell housing 224 may include a cross-sectional width 219 that is relatively thin. For example, the cell housing 224 in the implementation of FIG. 2F may be formed from a flexible or malleable material (e.g., a foil, such as a metal foil, or film, such as an aluminum-coated plastic film). The cross-sectional width 219 of the cell housing 224 may be as low as, or less than, 0.1 mm, 0.05 mm, 0.02 mm, or 0.01 mm to provide flexible or malleable housing for the pouch battery cell. In one or more implementations, a terminal 216 and a terminal 218 in the pouch cell implementation of FIG. 2F may be formed from conductive tabs (e.g., foil tabs) that are coupled (e.g., welded) to the anode 208 and the cathode 212 respectively, and sealed to the pouch that forms the cell housing 224 in these implementations. In the examples of FIGS. 2C, 2E, and 2F, the terminal 216 and the terminal 218 are formed on the same side (e.g., a top side) of the battery cell 120. However, this is merely illustrative and, in other implementations, the terminal 216 and the terminal 218 may formed on two different sides (e.g., opposing sides, such as a top side and a bottom side) of the battery cell 120. The terminal 216 and the terminal 218 may be formed on a same side or difference sides of the cylindrical cell of FIG. 2D in various implementations.

In one or more implementations, a battery module, a battery pack, a battery unit, or any other battery may include some battery cells that are implemented as solid-state battery cells and other battery cells that are implemented with liquid electrolytes for lithium-ion or other battery cells having liquid electrolytes. In one or more implementations, one or more of the battery cells may be included a battery module or a battery pack, such as to provide an electrical power supply for components of a vehicle and/or a building previously described, or any other electrically powered component or device. A cell housing of the battery cell can be disposed in the battery module, the battery pack, or installed in any of the vehicle, the building, or any other electrically powered component or device.

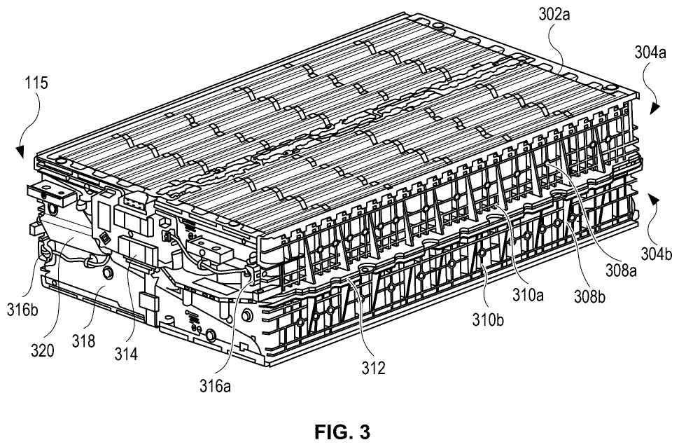

FIG. 3 illustrates a perspective view of a cover 302a for the battery module 115 in accordance with one or more implementations of the present disclosure. The cover 302a may represent an additional cover which will be shown and described below. In the example shown in FIG. 3, the battery module 115 includes a submodule 304a and a submodule 304b. Based on their respective positions and the orientation shown in FIG. 3, the submodule 304a and the submodule 304b may be referred to as a top submodule and a bottom submodule, respectively. As shown, the submodule 304a and the submodule 304b may include a cell carrier 308a and a cell carrier 308b, respectively. In one or more implementations, each of the cell carriers 308a and 308b may take the form of a monolithic unitary body (e.g., a molded body formed from plastic and/or other materials), and may include a structural feature 310a and a structural features 310b, respectively, along the sidewalls of thereof. The structural features 310a and 310b may reinforce the strength of the sidewalls of the cell carriers 308a and 308b, respectively, and thereby reduce or eliminate the need for additional structural reinforcing components for the battery module 115, such as shear walls attached to the cell carriers 308a and 308b. Also, a cold plate 312 is disposed between the submodule 304a and the submodule 304b. The cold plate 312 may be in thermal contact (e.g., thermally couple) with battery cells (not visible in FIG. 3) in the submodule 304a and battery cells (not visible in FIG. 3) in the submodule 304b in order to provide thermal control for respective battery cells of both the submodule 304a and the submodule 304b.

The cover 302a may be disposed on a top of the battery module 115, and an additional cover (shown below, similar to the cover 302a) may be disposed on a bottom of the battery module 115. Also, a balancing voltage and temperature (BVT) module 314 may communicatively couple to a thermistor assembly 316a and to a thermistor assembly 316b. The BVT module 314 may take the form a modular assembly of various electrical components to monitor or control components of the battery subassembly. For example, the BVT module 314 may include a circuit board that is attached to a housing of the BVT module 314. The BVT module 314 may include various connectors to couple with, for example, a thermistor, a voltage sensor, and/or a communication device, as non-limiting examples. The thermistor may measure a temperature of the battery module 115, a battery subassembly, and/or a battery cell thereof. The voltage sensor or balancer may sense or control voltage that flows through the battery module 115, a battery subassembly, and/or a battery cell thereof. The communication device may receive, transmit, or analyze data associated with the battery module 115, a battery subassembly, and/or a battery cell thereof. Several busbars may be integrated. For example, a busbar 318 (e.g., a positive busbar) may electrically couple to respective first terminals (e.g., the positive terminals) of the battery cells of the submodule 304a and the submodule 304b, and a busbar 320 (e.g., a negative busbar) may electrically couple to respective second terminals (e.g., the negative terminals) of the battery cells of the submodule 304a and the submodule 304b.

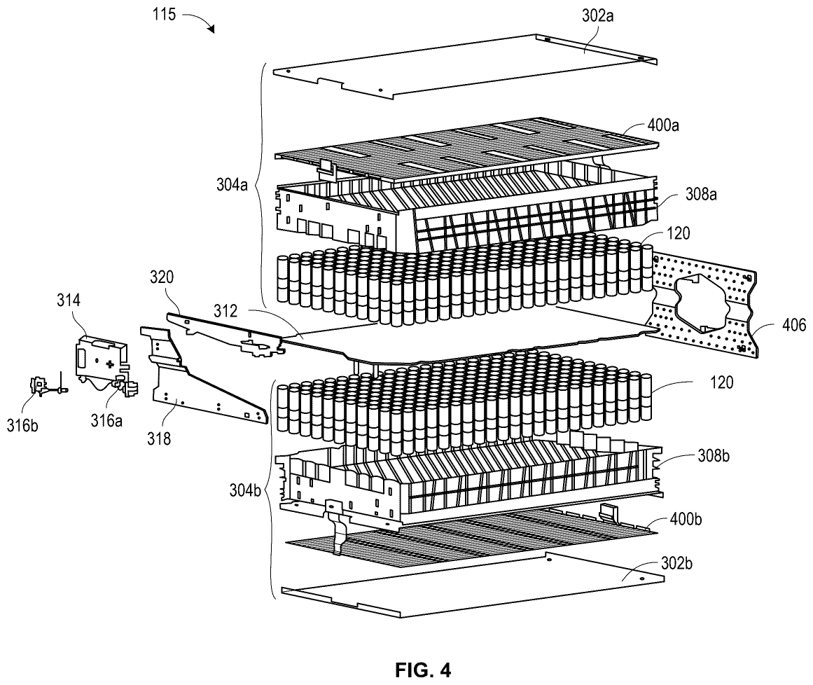

FIG. 4 illustrates an exploded perspective view of the battery module 115 of FIG. 3, in which the battery cells 120 of the submodule 304a and the battery cells 120 of the submodule 304b are shown. As shown, the cover 302a may be provided for the submodule 304a and a cover 302b may be provided for the submodule 304b. In one or more examples described herein, the battery module 115, a subset of the components of the battery module 115 (e.g., the submodule 304a, the submodule 304b, and/or another subset of the components of the battery module 115) shown in FIG. 3 and/or FIG. 4, or any other grouping of battery cells (e.g., including a battery pack that includes multiple battery modules and/or other battery subassemblies) may be referred to as a battery subassembly.

In the example shown in FIG. 4, a CCA 400a and a CCA 400b are also visible. As discussed in further detail hereinafter, when the battery module 115 is assembled, the CCAs 400a and 400b may each take the form of an apparatus that connects the respective terminals of the battery cells 120 of the submodule 304a and of the submodule 304b to the busbar 318 and the busbar 320. As shown in FIG. 4, a series busbar 406 may also be provided (e.g., on an opposing end of the cell carriers 308a and 308b from the end of the respective cell carriers at which the busbar 318 and the busbar 320 are mounted). For example, the series busbar 406 may electrically couple the battery cells 120 of the submodule 304a to the battery cells 120 of the submodule 304b.

The battery cells 120 of the submodule 304a may be inserted into a crate structure formed by the cell carrier 308a of the submodule 304a, and the battery cells 120 of the submodule 304b may be inserted into a crate structure formed by the cell carrier 308b of the submodule 304b. As shown in FIGS. 3 and 4, the orientation of the cell carrier 308a and the battery cells 120 of the submodule 304a may be substantially opposite (e.g., upside down with respect) to the orientation of the cell carrier 308b and the battery cells 120 of the submodule 304b. In this way, the CCA 400a and the CCA 400b may be provided at or near an outer layer of the submodule 304a and submodule 304b, respectively, for connection to the respective terminal(s) of the battery cells 120 disposed in the submodules 304a and 304b. Additionally, the cold plate 312 may thermally couple with the battery cells 120 of the submodule 304a and with the battery cells 120 of the submodule 304b. In this regard, the cold plate 312 may dissipate thermal energy from the battery cells 120 of the submodule 304a and from the battery cells 120 of the submodule 304b.

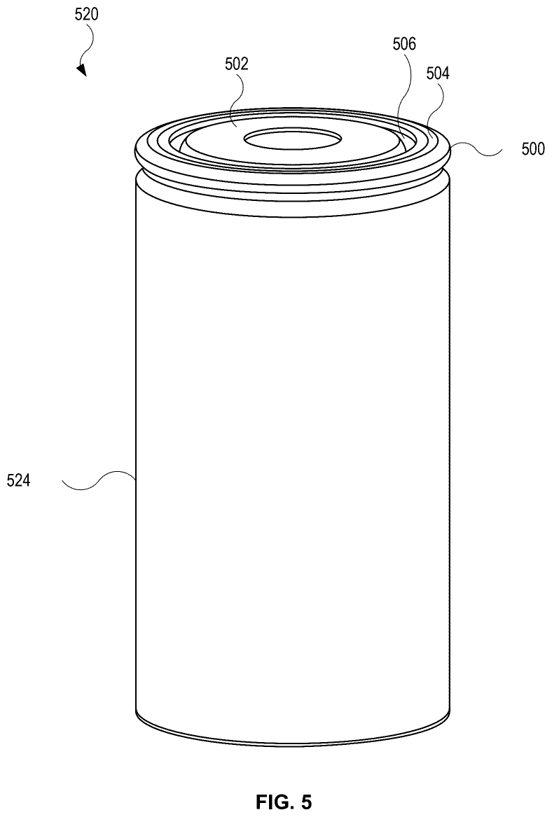

FIG. 5 illustrates a perspective view of an example of a battery cell 520, implemented as a cylindrical cell with a cylindrical cell housing 524, in accordance with one or more implementations. In the example of FIG. 5, the battery cell 520 includes a cap 500 that includes a central portion 502 and a peripheral rim 504. In one or more implementations, the central portion 502 may be implemented as a terminal, such as a positive terminal of the battery cell 520. In one or more implementations, the peripheral rim 504 may be implemented as a terminal, such as a negative terminal of the battery cell 520. In one or more implementations, the battery cell 520 may include a gasket 506 that is disposed at least partially beneath the peripheral rim 504. For example, the gasket 506 may seal an internal cavity of the battery cell 520 (e.g., enclosed by the cylindrical cell housing 524 and the cap 500) from the external environment of the battery cell 520.

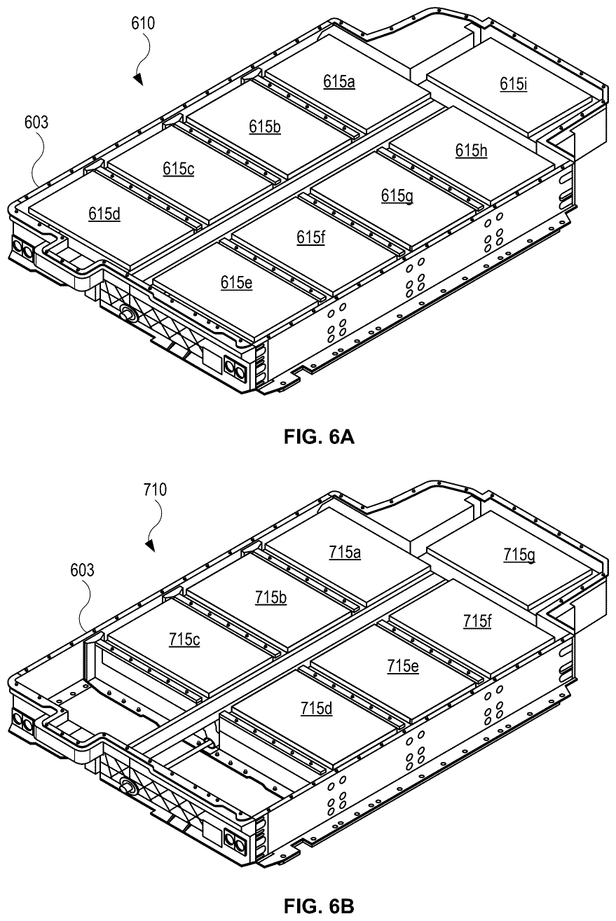

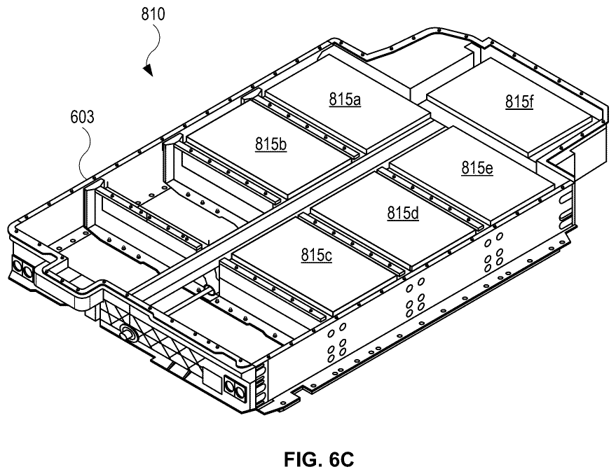

FIG. 6A, FIG. 6B, and FIG. 6C illustrate perspective views of examples of battery packs, in accordance with one or more implementations of the present disclosure. Each of the battery packs shown in FIGS. 6A, 6B and 6C may include several battery modules in a battery frame. Each battery module shown in FIGS. 6A, 6B, and 6C may include any feature shown and/or described herein for a battery module (e.g., battery module shown in FIG. 4). Each of the battery modules shown in FIGS. 6A, 6B, and 6C may be disposed in a battery pack frame, which may include any feature shown and/or described herein for a battery pack frame (e.g., the battery pack frame 203 shown in FIG. 2A).

Referring to FIG. 6A, a battery pack 610 includes a battery module 615a, a battery module 615b, a battery module 615c, a battery module 615d, a battery module 615e, a battery module 615f, a battery module 615g, a battery module 615h, and a battery module 615i, each of which are positioned in an enclosure 603 (e.g., battery pack frame). Referring to FIG. 6B, a battery pack 710 includes a battery module 715a, a battery module 715b, a battery module 715c, a battery module 715d, a battery module 715e, a battery module 715f, and a battery module 715g, each of which are positioned in the enclosure 603. Referring to FIG. 6C, a battery pack 810 includes a battery module 815a, a battery module 815b, a battery module 815c, a battery module 815d, a battery module 815e, and a battery module 815f, each of which are positioned in the enclosure 603.

Based on the different number of battery modules between the battery pack 610 in FIG. 6A, the battery pack 710 in FIG. 6B, and the battery pack 810 in FIG. 6C, the battery packs 610, 710 and 810 may provide different energy output, including a different voltage and/or a different energy storage capacity. For example, the battery pack 610, having more battery modules, may provide a higher voltage and/or greater energy storage capacity. However, while the numbers of battery modules for a battery pack may differ between the battery pack 610, the battery pack 710, and the battery pack 810 in FIG. 6A, FIG. 6B, and FIG. 6C, respectively, a battery pack frame (e.g., the enclosure 603) may include the same size and shape. In this regard, a battery pack frame having a unitary size and shape may provide an internal volume that is utilized with different numbers of battery modules. Beneficially, vehicles integrating the enclosure 603 may be equipped with a different number of battery modules, thus offering users different options based on user preferences, including but not limited to, acceleration (dependent upon voltage), driving range (dependent upon energy storage capacity), and cost (dependent upon the number of battery modules).

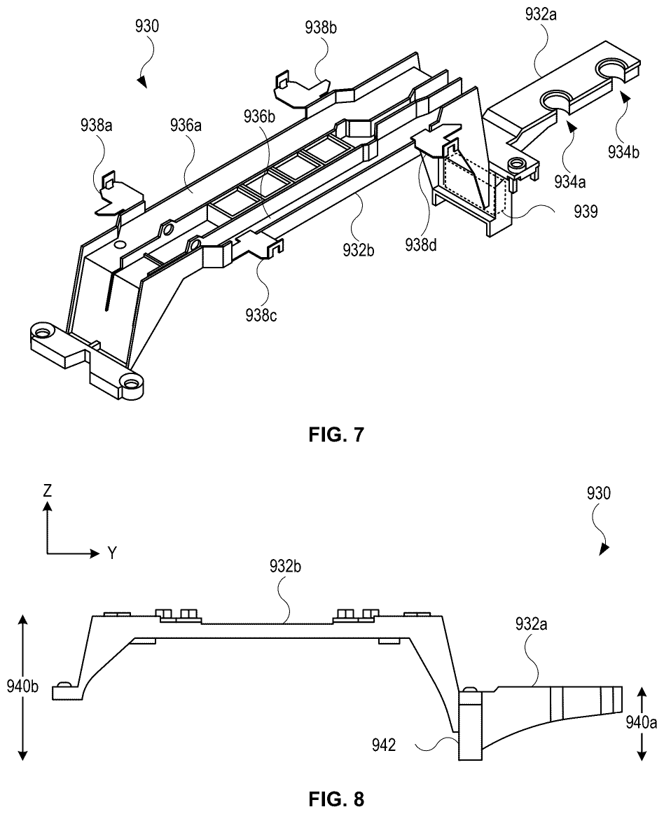

FIG. 7 illustrates a perspective view of an example of a bridging component 930, in accordance with one or more implementations of the present disclosure. The bridging component 930 may be referred to as a bracket (e.g., bridge bracket), a bridging structure, or the like. The bridging component 930 may take the form of an apparatus that is integrated with battery packs, including battery packs in which an internal volume of a battery pack frame (e.g., enclosure 603 shown in FIGS. 6A-6C) provides an additional space or void that is present based on the number of battery modules of the battery pack being less than the total number of battery modules that could be held within a battery pack frame. For example, FIG. 6B and FIG. 6C illustrate the enclosure 603 in which the battery modules within the enclosure 603 are less than the total capacity that the enclosure 603 could otherwise receive. In this regard, the bridging component 930 may be positioned in the space that would otherwise be occupied by battery modules and may carry various components of a battery pack. Further, the bridging component 930 may be used carry the various components that would otherwise be carried by a different component when a battery pack frame is fully occupied with battery modules (e.g., as shown in FIG. 6A).

The bridging component 930 may include different regions designed to perform different functions. For example, the bridging component 930 may include a portion 932a designed to carry components, including a cooling manifold (e.g., cooling lines for the cooling manifold), which is not shown in FIG. 7. In this regard, the portion 932a may include an opening 934a and an opening 934b. Each of the openings 934a and 934b may take the form of partial opening, cavity, or indentations in the portion 932a such that each of the openings 934a and 934b may carry a tube (e.g., a cooling line).

The bridging component 930 may further include a portion 932b designed to perform different functions. The portion 932b may carry busbars (not shown in FIG. 7) designed to complete electrical circuits for battery modules in a battery pack. As shown, the portion 932b includes a surface 936a and a surface 936b, each of which provides a receiving surface for a busbar. In order to retain the busbars, the portion 932b may include additional features. For example, the portion 932b may further include a clip 938a, a clip 938b, a clip 938c, and a clip 938d. Each of the clips 938a, 938b, 938c, and 938d are designed to rotate and fold over (and cover) a busbar. This will be shown below.

The bridging component 930 may be formed from a molding operation, such as injection molding or over molding as non-limiting examples. In this regard, the body of the bridging component 930 may be formed from a non-metal material (or materials) such as a polymer, including plastic. However, the bridging component 930 may be reinforced by a metal. For example, the bridging component 930 may include an insert 939 embedded, or at least partially embedded, within the non-metal body of the bridging component 930. The non-metal body of the bridging component 930 may be over molded onto the insert 939. In one or more implementations, the insert 939 is formed from a metal such as aluminum or aluminum alloy. Beneficially, the bridging component 930 may be structurally reinforced by the insert 939 while also remaining relatively lightweight.

FIG. 8 illustrates a side view of an example of a bridging component 930, in accordance with one or more implementations of the present disclosure. The portions 932a and 932b of the bridging component 930 may be formed at different elevations, or heights. For example, the portion 932a includes an elevation 940a and the portion 932b includes an elevation 940b that is different than the elevation 940a. For example, the elevation 940b is greater than the elevation 940a. The bridging component 930 may include a column 942 that positions, or approximately positions, the portion 932a at the elevation 940a.

In one or more implementations, the elevation 940a and the elevation 940b of the portion 932a and the portion 932b, respectively, are selected such that the portions 932a and 932b carry or hold components of a battery pack in their approximate positions when the battery pack includes the maximum number of battery modules and the bridging component 930 is not present. For example, the elevation 940a of the portion 932a may be selected such that cooling tubes carried by the portion 932a are at or near their respective positions when the bridging component 930 is not present. Also, the elevation 940a and the elevation 940b of the portion 932a and the portion 932b, respectively, may be selected to position components in a manner that facilitates electrical and/or mechanical connections. For example, the elevation 940b of the portion 932b may be selected such that busbars carried by the portion 932b are at or near other existing busbars, thus facilitating electrical and mechanical connections between the busbars.

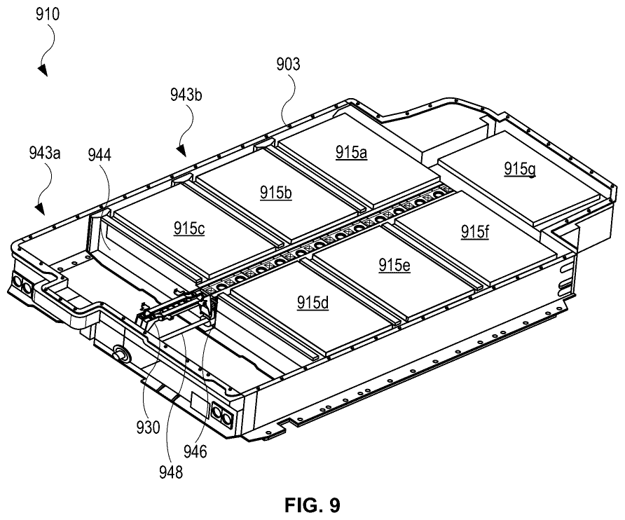

FIG. 9 illustrates a perspective view of an example of a battery pack 910, further showing the bridging component 930 integrated with the battery pack 910, in accordance with one or more implementations of the present disclosure. As shown, the battery pack 910, or battery subassembly, includes a battery module 915a, a battery module 915b, a battery module 915c, a battery module 915d, a battery module 915e, a battery module 915f, and a battery module 915g, each of which is positioned in an enclosure 903 that defines an internal volume. Accordingly, the battery pack 910 includes seven battery modules. In this regard, the enclosure 903 (including walls of the enclosure 903) may define in part a space 943a in the internal volume, with the space 943a representing a location that could otherwise carry additional battery modules. As shown, the bridging component 930 may be positioned in, and span, the space 943a of the enclosure 903.

The battery pack 910 may include a crossmember 944 designed to provide lateral support for an impact event to the battery pack 910. Based on the position of the crossmember 944, the space 943a is defined in part by the crossmember 944 (in addition to the enclosure 903). Further, the crossmember 944 may separate each of the battery modules (e.g., the battery modules 915a, 915b, 915c, 915d, 915e, 915f, and 915g) from the space 943a (e.g., a volume that is not occupied with battery module). In the regard, the enclosure 903 and the crossmember 944 may further define a space 943b in the internal volume, with the space 943b representing a location that carries the battery modules 915a, 915b, 915c, 915d, 915c, 915f, and 915g. The crossmember 944 may include an opening 946, and the bridging component 930 may pass through the opening 946 of the crossmember 944. Additionally, the bridging component 930 may be designed to accommodate other components of the battery pack 910, such as a tube 948 passing through and below the bridging component 930.

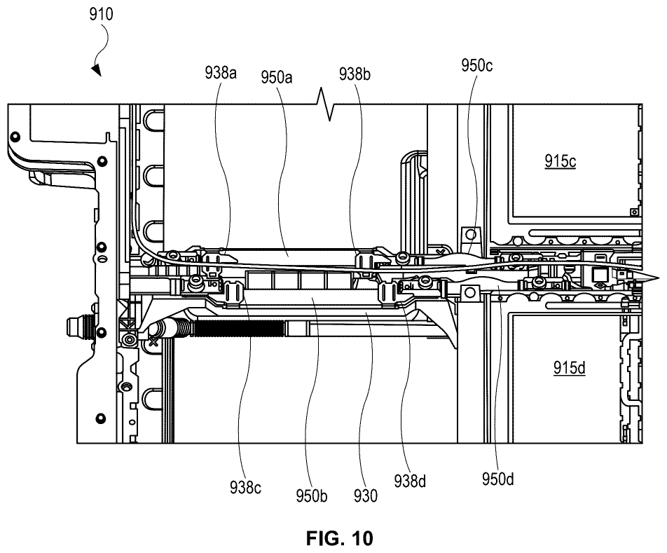

FIG. 10 illustrates an enlarged aerial view of the battery pack 910 and the bridging component 930, in accordance with one or more implementations of the present disclosure. As shown, the battery pack 910 includes a busbar 950a and a busbar 950b carried by the bridging component 930 (and in particular, the portion 932b of the bridging component 930 shown in FIG. 8). To secure the busbar 950a, the clips 938a and 938b are folded over and onto the busbar 950a, thus covering the busbar 950a. Similarly, to secure the busbar 950b, the clips 938c and 938d are folded over and onto the busbar 950b, thus covering the busbar 950b.

Additionally, the battery pack 910 may include a busbar 950c and a busbar 950d that provide an electrical pathway for a high voltage circuit with battery modules, such as the battery modules 915c and 915d. As shown, each of the busbars 950c and 950d are positioned, or at least partially positioned between, the battery modules 915c and 915d. The busbars 950a and 950b, carried by the bridging component 930, may electrically couple with the busbars 950c and 950d, and accordingly, the busbars 950a and 950b are part of the high voltage circuit. Further, based on the positioning of the busbars 950a and 950b by the bridging component 930 (including the elevation 940b provided by the portion 932b shown in FIG. 8), the busbars 950a and 950b may lie, or approximately lie, in the same plane (e.g., X-Y plane) as that of the busbars 950c and 950d. Put another way, the busbars 950a and 950b may be co-planar with respect to the busbars 950c and 950d. Beneficially, by positioning the busbars 950a and 950b co-planar with respect to the busbars 950c and 950d, the bridging component 930 may facilitate mechanical connections to the busbars 950a and 950b.

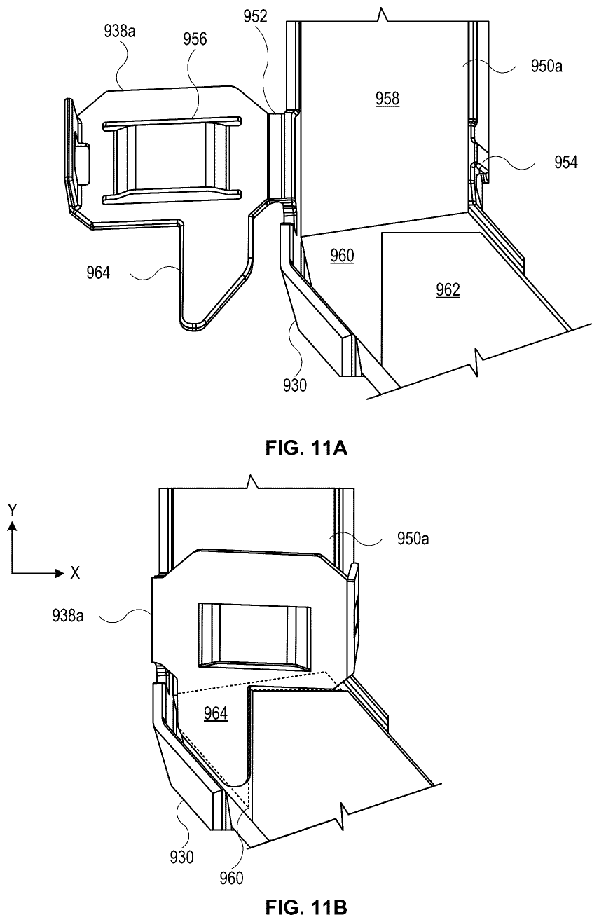

FIG. 11A and FIG. 11B illustrate enlarged aerial views of an example of the clip 938a of the bridging component 930, in accordance with one or more implementations of the present disclosure. The clip 938a may be representative of the clips 938b, 938c, and 938d (shown in FIG. 10). Referring to FIG. 11A, the clip 938a is in the open position. Also, the busbar 950a is positioned on the bridging component 930. The clip 938a may connect to the bridging component 930 by a hinge 952, with the hinge 952 allowing the clip 938a to move (e.g., rotate) with respect to the busbar 950a and be positioned over the busbar 950a. The bridging component 930 may further include a tab 954 designed to receive the clip 938a. The clip 938a may include features designed to apply additional force. For example, the clip 938a may include a spring tab 956, or spring, designed engage the busbar 950a and provide additional securing force.

Also, the busbar 950a may include an insulated portion 958 and an exposed portion 960. The insulated portion 958 may refer to a region of the busbar 950a that is electrically insulated, while the exposed portion 960 may refer to a region of the busbar 950a that is not electrically insulated. Additionally, a location 962 represents a region that covers the busbar 950a (e.g., other structures including connections), thus making the busbar 950a inaccessible in a location corresponding to the location 962. The exposed portion 960 of the busbar 950a represents a non-covered, high voltage region. In order to cover the exposed portion 960, the clip 938a may include an extension 964.

Referring to FIG. 11B, the clip 938a is in a closed position (based on movement provided by the hinge 952 shown in FIG. 11A) and coupled with the tab 954 (shown in FIG. 11A). While the clip 938a and the spring tab 956 provide a securing force to the busbar 950a, the clip 938a and the spring tab 956 may allow some relative movement of the busbar 950a along the X- and/or Y-directions (in Cartesian coordinates) in order to position the busbar 950a in a desired manner (e.g., to align fastening holes of the busbar 950a with other fastening holes). Further, in the closed position of the clip 938a, the extension 964 covers, or at least substantially covers, the exposed portion 960 (shown as dotted lines). Beneficially, the exposed portion 960 is essentially inaccessible and provides further safety by electrically isolating the busbar 950a.

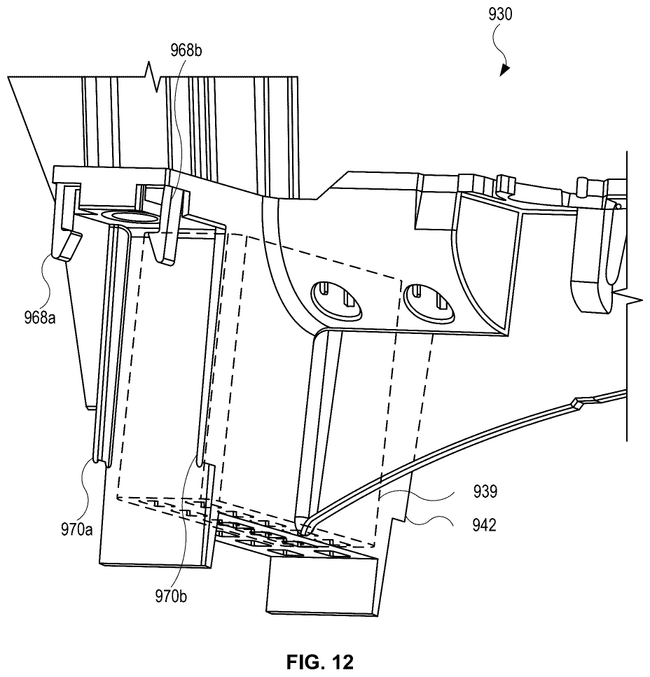

FIG. 12 illustrates an enlarged perspective view of a bridging component 930, showing additional features of the bridging component 930, in accordance with one or more implementations of the present disclosure. The bridging component 930 may include several features designed to secure with a component (e.g., the crossmember 944 shown in FIG. 9). For example, the bridging component 930 may include a snap 968a and snap 968b. The snaps 968a and 968b, which may also be referred to as clips, may secure with the component. For example, the snaps 968a and 968b may bend in response to engaging the component and subsequently bend back to secure with the components. Based on the snaps 968a and 968b, other features, such as screws, fasteners, or adhesives, may not be required to secure the bridging component 930 with the component. Further, the bridging component 930 may include a guide 970a and a guide 970b that allow the component to slide along and between the guides 970a and 970b. Based on the guides 970a and 970b, the bridging component 930 may be more accurately and quickly secured with the component. Also, as shown, the column includes the guides 970a and 970b, and the insert 939 is positioned in the column 942.

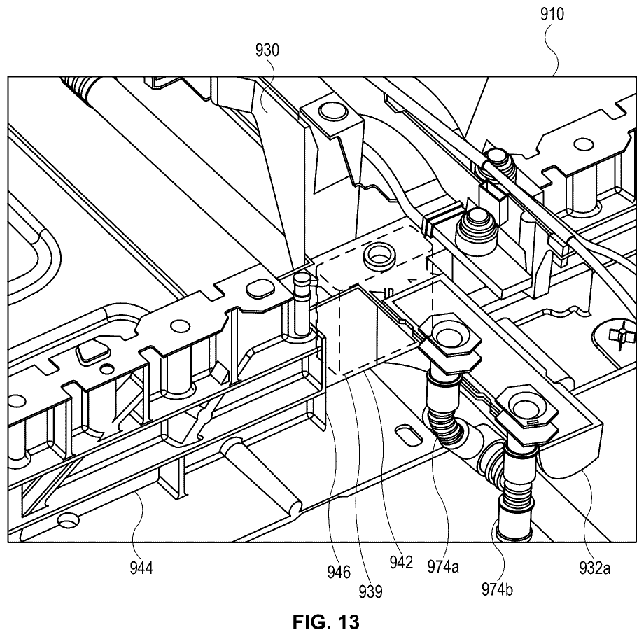

FIG. 13 illustrates an enlarged perspective view of the battery pack 910, showing the bridging component 930 coupled with the crossmember 944, in accordance with one or more implementations of the present disclosure. The snaps 968a and 968b as well as the guides 970a and 970b (all shown in FIG. 12) may assist in aligning and securing the bridging component 930 with the crossmember 944. When the bridging component 930 is coupled with the crossmember 944, the bridging component 930 passes through the opening 946 of the crossmember 944. Moreover, the column 942, including the insert 939 embedded within the column 942, is aligned with the crossmember 944 and positioned in the opening 946. Thus, the insert 939 is positioned within the opening 946. As a result, the insert 939 may add back at least some of the structural integrity lost by the opening 946 of the crossmember 944. Also, the portion 932a of the bridging component 930 may secure a cooling tube 974a and a cooling tube 974b of a cooling manifold of the battery pack 910. The cooling tubes 974a and 974b may be positioned, or approximately positioned, in a location that the cooling tubes 974a and 974b would otherwise be positioned without the bridging component 930.

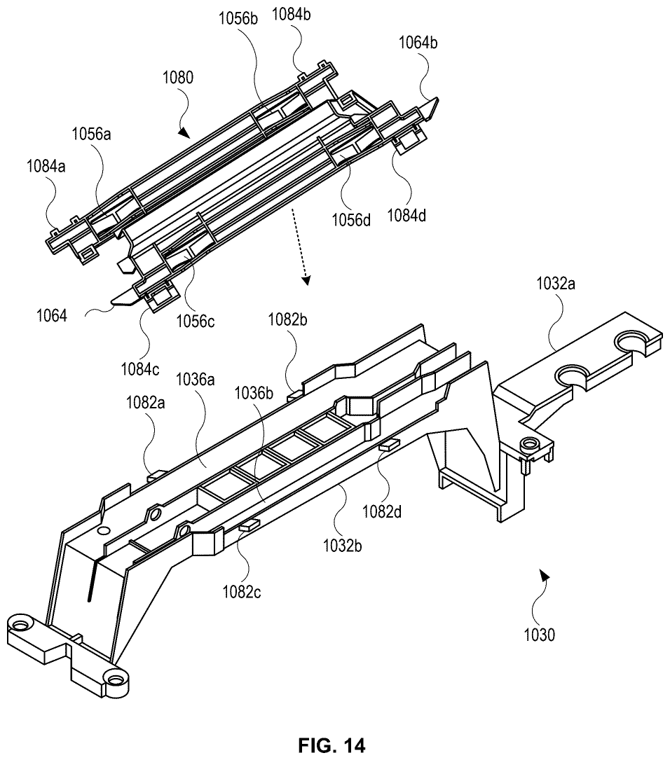

FIG. 14 illustrates an exploded view of an alternate example of a bridging component 1030, in accordance with one or more implementations of the present disclosure. Similar to the bridging component 930 (shown, e.g., in FIGS. 7 and 8), the bridging component 1030 may be referred to as a bracket (e.g., bridge bracket), a bridging structure, or the like. In this regard, the bridging component 1030 may take the form of an apparatus that is integrated with battery packs, including battery packs in which an internal volume of a battery pack frame provides an additional space or void that is present based on the number of battery modules of the battery pack being less than the total number of battery modules that could be held within a battery pack frame. Additionally, a cover 1080 may secure with the bridging component 1030 to secure multiple bus bars (not shown in FIG. 14). The cover 1080 may be formed form a non-metal material(s) to provide electrical isolation.

As shown, the bridging component 1030 include a portion 1032a designed to carry components, including a cooling manifold. The portion 1032a may include several openings for the colling manifold. Further, the bridging component 1030 may further include a portion 1032b designed to perform different functions, such as carry busbars designed to complete electrical circuits for battery modules in a battery pack. As shown, the portion 1032b includes a surface 1036a and a surface 1036b, each of which provides a receiving surface for a busbar.

In order to retain the busbars, the portion 1032b may include additional features. For example, the portion 1032b may further include an extension 1082a, an extension 1082b, an extension 1082c, and an extension 1082d. Each of the extensions 1082a, 1082b, 1082c, and 1082d are designed to couple with a respective fastener of the cover 1080. For example, the cover 1080 may include a fastener 1084a, a fastener 1084b, a fastener 1084c, and a fastener 1084d. Each of the fastener 1084a, the fastener 1084b, the fastener 1084c, and the fastener 1084d is designed to rotate over and couple to the extension 1082a, the extension 1082b, the extension 1082c, and the extension 1082d, respectively. Further, the cover 1080 may include an extension 1064 (representative of one or more extensions) designed to cover, or at least substantially coves, an exposed portion of a bus bar to prevent access to, and further electrically isolate, the exposed portion of the bus bar.

Also, the cover 1080 may include several spring tabs designed to provide additional securing force to bus bars carried by the cover 1080. For example, the cover 1080 includes a spring tab 1056a, a spring tab 1056b, a spring tab 1056c, and a spring tab 1056c. Each of the spring tabs 1056a, 1056b, 1056c, and 1056d may include one or more tabs designed engage and provide a securing force to a busy bar. In this regard, the spring tabs 1056a and 1056b may engage a bus bar positioned on the surface 1036a of the bridging component 1030, and the spring tabs 1056c and 1056d may engage a bus bar positioned on the surface 1036b of the bridging component 1030.

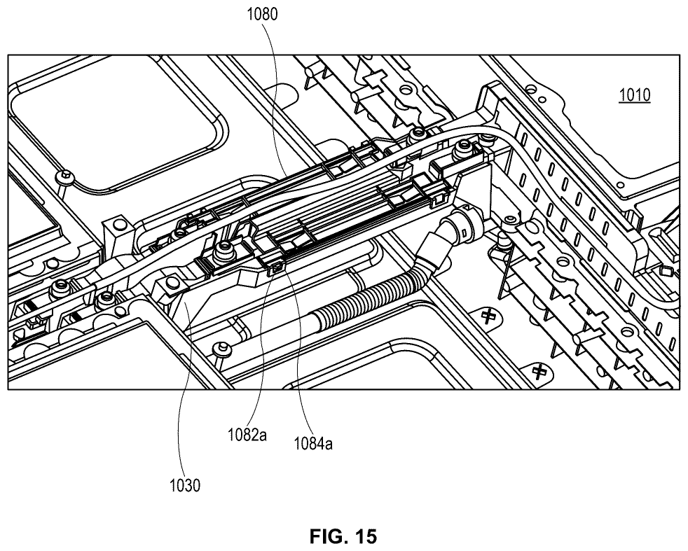

FIG. 15 illustrates a perspective view of an example of a battery pack 1010, further showing a bridging component 1030 (shown in FIG. 14) integrated with the battery pack 1010, in accordance with one or more implementations of the present disclosure. As shown, the battery pack 1010 includes a busbar and a busbar, each covered by the cover 1080 and carried by the bridging component 1030 (and in particular, the portion 1032b of the bridging component 1030 shown in FIG. 14). To secure the busbars, the cover 1080 may cover, or at least substantially cover, the bus bars. As shown, the fastener 1084a of the cover 1080 is folded over and engaged with the extension 1082a of the bridging component 1030. This relationship may be representative of other fasteners and extensions.

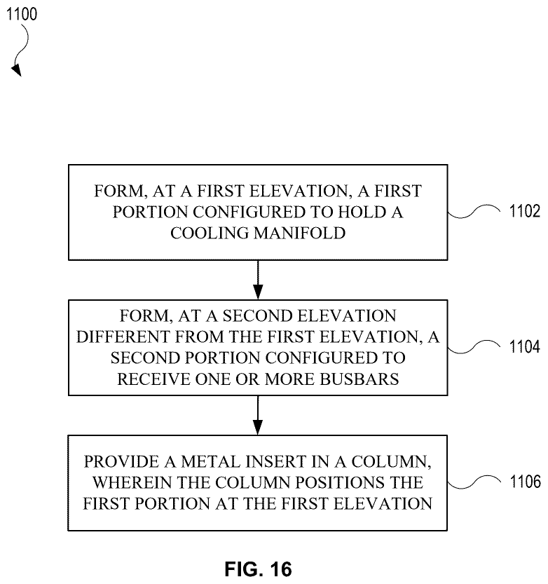

FIG. 16 illustrates a flow diagram showing an example of a process 1100 that may be performed for forming a bridging component, in accordance with one or more implementations of the present disclosure. For explanatory purposes, the process 1100 is primarily described herein with reference to bridging components shown in FIGS. 7-15. However, the process 1100 is not limited to the bridging components shown in FIGS. 7-15, and one or more blocks (or operations) of the process 1100 may be performed by one or more other components of other suitable moveable apparatuses, devices, or systems. Further for explanatory purposes, some of the blocks of the process 1100 are described herein as occurring in serial, or linearly. However, multiple blocks of the process 1100 may occur in parallel. In addition, the blocks of the process 1100 need not be performed in the order shown and/or one or more blocks of the process 1100 need not be performed and/or can be replaced by other operations.

At block 1102, a first portion is formed at a first elevation. The first portion is configured to hold a cooling manifold. The first portion (e.g., portion 932a shown in FIG. 7) may hold cooling tubes (e.g., cooling tubes 974a and 974b shown in FIG. 13) of the cooling manifold.

At block 1104, a second portion is formed at a second elevation different from the first elevation. The second portion (e.g., portion 932b) is configured to receive one or more busbars (e.g., busbars 950a and 950b shown in FIG. 10). Further, the second elevation (e.g., elevation 940b shown in FIG. 8) may be greater than the first elevation (e.g., elevation 940a shown in FIG. 8).

At block 1106, a metal insert is provided in a column. The column (e.g., column 942) shown in FIG. 1) may position the first portion at the first elevation.

Although not shown, the process 1100 may further including molding one or more materials to form the bridging component, including over molding the metal insert.

Aspects of the subject technology can help extend the life of a battery in a vehicle. This can help facilitate the functioning of and/or proliferation of batteries, which can positively impact the climate by reducing greenhouse gas emissions.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. An apparatus, comprising:
a bridging component comprising a first portion configured to hold a cooling manifold at a first elevation, and further comprising a second portion configured to hold one or more busbars at a second elevation different from the first elevation.

2. The apparatus of claim 1, wherein the second elevation is greater than the first elevation.

3. The apparatus of claim 1, wherein the bridging component further comprises a clip configured to at least partially cover a busbar of the one or more busbars.

4. The apparatus of claim 3, wherein the clip is coupled to the second portion by a hinge.

5. The apparatus of claim 3, wherein the clip comprises a spring tab configured to contact the busbar in a closed position of the clip.

6. The apparatus of claim 3, wherein the clip comprises an extension configured to cover an exposed portion of the busbar in a closed position of the clip.

7. The apparatus of claim 1, wherein the bridging component further comprises:
a column formed from a first material; and
an insert positioned in the column, the insert comprising a second material different from the first material.

8. The apparatus of claim 7, further comprising a snap, wherein the bridging component further comprises:
the column comprises a guide configured to receive a crossmember, and
the snap is configured to secure with the crossmember in response the guide receiving the crossmember.

9. A battery subassembly, comprising:
an enclosure for a battery pack, the enclosure defining an internal volume configured to receive battery modules;
a crossmember positioned in the internal volume and coupled with the enclosure, wherein the enclosure and crossmember define a first space in the internal volume; and
a bridging component positioned in the first space, the bridging component comprising a first portion configured to hold a cooling manifold for the battery modules, and further comprising a second portion configured to hold a first busbar that electrically couples with the battery modules.

10. The battery subassembly of claim 9, wherein:
the enclosure and crossmember further define a second space in the internal volume, and
the battery modules are positioned in the second space.

11. The battery subassembly of claim 10, wherein the battery modules are not located in the first space.

12. The battery subassembly of claim 9, wherein:
the crossmember comprises an opening, and
the bridging component further comprises:
a column positioned in the opening, the column formed from a non-metal; and
an insert positioned in the column, the insert comprising a metal.

13. The battery subassembly of claim 9, wherein:
the crossmember comprising an opening, and
the bridging component passes through the opening.

14. The battery subassembly of claim 9, wherein the bridging component further comprises a clip configured to at least partially cover the first busbar.

15. The battery subassembly of claim 14, wherein the clip is coupled to the second portion by a hinge.

16. The battery subassembly of claim 14, wherein the clip comprises:
a spring tab configured to contact the first busbar in a closed position of the clip; and
an extension configured to cover an exposed portion of the first busbar in a closed position of the clip.

17. The battery subassembly of claim 9, wherein the battery modules are not located in the first space.

18. A vehicle, comprising:
a battery subassembly comprising:
an enclosure for a battery pack, the enclosure defining an internal volume comprising a first space configured to receive a first battery module and a second space configured to receive a second battery module;
a crossmember positioned in the internal volume and coupled with the enclosure; and
a bridging component spanning the second space, the bridging component comprising a first portion configured to hold a cooling manifold for the first battery module and the second battery module, and further comprising a second portion configured to hold a first busbar that electrically couples with the first battery module and the second battery module.

19. The vehicle of claim 18, wherein the first battery module and the second battery module are not located in the second space.

20. The vehicle of claim 18, wherein the first battery module and the second battery module are located in the first space.
